(19) United States
(12) Patent Application Publication
(10) Pub. No.: US 2006/0123096 A1
(43) Pub. Date: Jun. 8, 2006

(54) Method and Apparatus for Remote Site Access of a Multi-Core Processor Computing System

(76) Inventor: Brian Carr Taggart, Phoenix, AZ (US)

Correspondence Address: GOT PATENT? LLC, P.O. BOX 93891, PHOENIX, AZ, 85070-3891, US

(21) Appl. No.: 10/904,672

(22) Filed: Nov. 22, 2004

(51) Int. Cl. G06F 15/16

(52) U.S. Cl. 709/217

(57) ABSTRACT

A multi-core processor computer system is described. The computer system includes a wireless communicator that enables access from at least one remote access site comprised of hardware equipped with a wireless communicator. This remote access site may not include a processor as part of the hardware. This remote hardware can access the capabilities of the multi-core processor computer and the computing system via wireless communicators and can allocate a dedicated core within the multi-core processor to the remote user, thereby enabling parallel, independent access to the computing system that can be shared by at least one additional user. The number of remote users can be correlated to the number of cores residing in the multi-core processor computing system. A process of wireless communication between the remote access sites and the computing system to enable independent computing processing capability is also described.

In order to understand the manner in which embodiments are obtained, a more particular description of various embodiments briefly described above will be rendered by reference to the appended drawings. These drawing depict embodiments that are not necessarily drawn to scale and are not to be considered to be limiting of its scope. Some embodiments will be described and explained with additional specificity and detail through the use of the accompanying drawings.

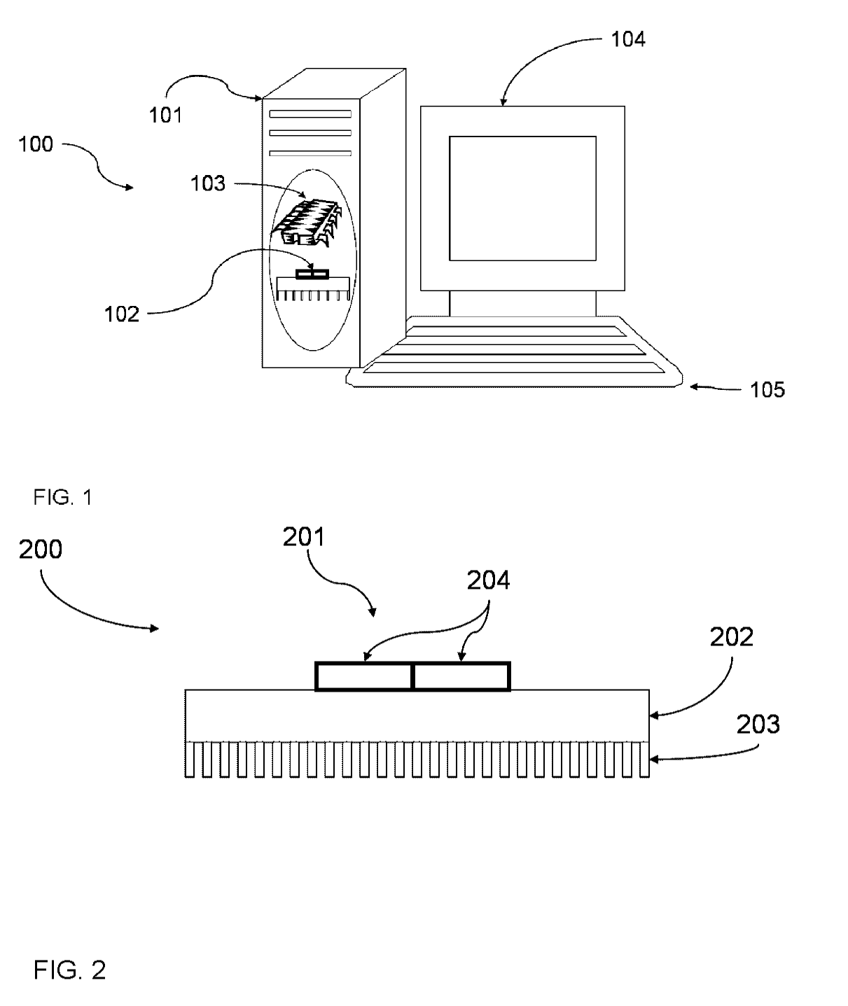

FIG. 1 is a depiction of a computing system with a multi-core processor according to an embodiment.

FIG. 2 is a depiction of a multi-core processor according to an embodiment.

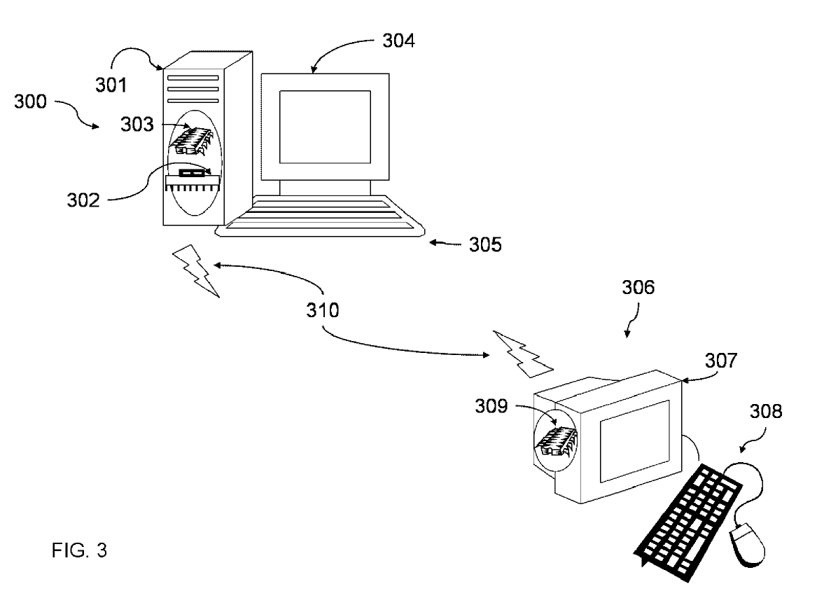

FIG. 3 is a depiction of a computing system with a multi-core processor used in conjunction with a remote access site using a wireless communicator housed in a monitor according to an embodiment.

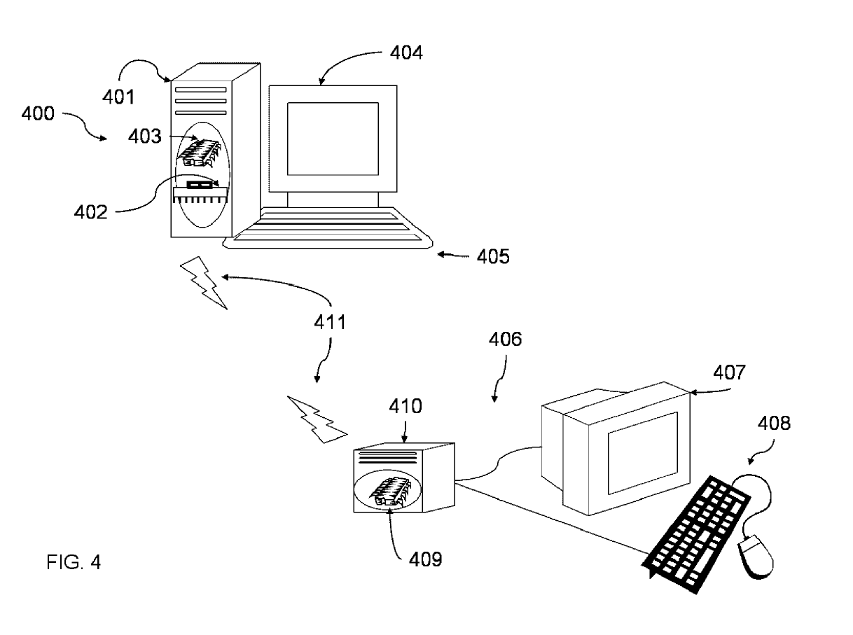

FIG. 4 is a depiction of a computing system with a multi-core processor used in conjunction with a remote access site using a separate wireless communicator device connected to the remote site hardware according to an embodiment

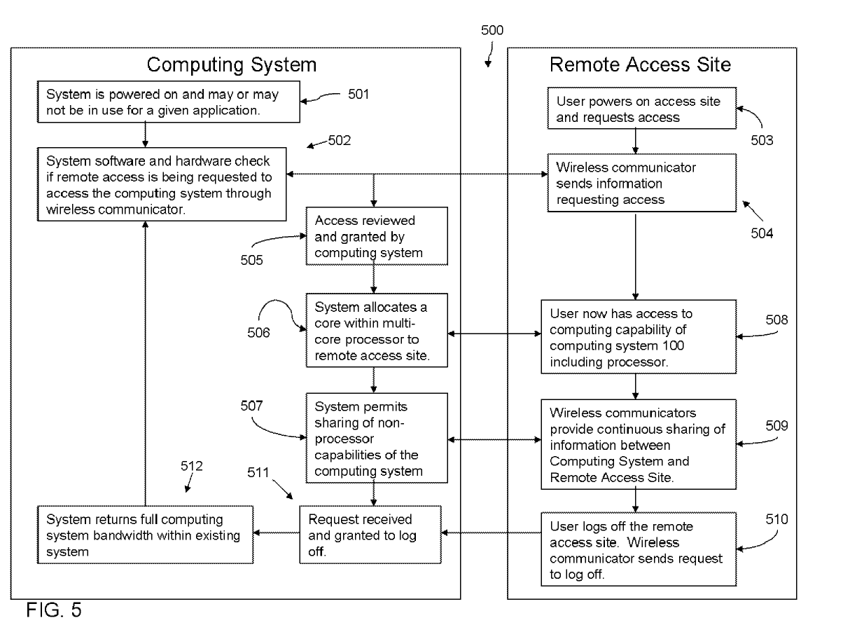

FIG. 5 is a process flow diagram according to various embodiments.

The following description includes terms, such as wireless communicators, computing system, etc. that are used for descriptive purposes only and are not to be construed as limiting. The embodiments of a device or computing system described herein can be manufactured, used, or shipped in a number of positions and orientations. The terms “die”, “multi-core processor” and “processor” generally refer to the physical object that is the basic workpiece that is transformed by various process operations into the desired integrated circuit device. A multi-core die is usually singulated from a wafer, and wafers may be made of semi-conducting, non-semiconducting, or combinations of semi-conducting and non-semiconducting materials. A multi-core processor can also be manufactured using more than one physical die singulated from a wafer and packaged together in processor.

Reference will now be made to the drawings wherein like structures will be provided with like reference designations. In order to show the structure and process embodiments most clearly, the drawings included herein are diagrammatic representations of embodiments. Thus, the actual appearance of the fabricated structures, for example in a photomicrograph, may appear different, while still incorporating the essential structures of embodiments. Moreover, the drawings show only the structures necessary to understand the embodiments. Additional structures known in the art have not been included to maintain the clarity of the drawings.

Disclosed embodiments relate to the method and apparatus for creating a system for computer capability access points from remote locations to a single computer terminal equipped with at least one multi-processor central processing unit. In an embodiment, a computing system is depicted that utilizes a single computer equipped with a multi-core processor (central processing unit), but not limited to one. In another embodiment, a structure embodiment is depicted showing an example of a multi-core processor used in the computing system. In another embodiment, the computing system is in wireless communication with a remote work site that permits multiple parallel access to the multi-processor computer system without the need for a host computer and central processing unit at the remote locations.

FIG. 1 is a depiction of a computing system 100 according to an embodiment. The computing system 100 includes at least one multi-core processor 102. The multi core-core processor 102 typically is housed within a computer terminal 101. The computing system 100 includes at least one wireless communicator 103 that is housed or attached to the computer terminal 101. The wireless communicator 103 enables the computing system 101 to both receive and transmit information from external sources without the need for wires using, but not limited too, wireless fidelity standards. Terminal 101 depicts the housing for the computing hardware, including, but not limited too, chipsets, graphics cards, input/output devices, and software to control and manage the functions of the hardware and the multi-core processor 102. External hardware such as a monitor 104 and keyboard 105 is used as user interface to access the hardware and software residing within or attached to the terminal 101.

FIG. 2 is a depiction of a multi-core processor 200 according to an embodiment. The multi-core processor 200 includes at least one piece of silicon 201 which is enclosed in a package 202. In this example, a number of electrically conducting pins 203 is used to socket into the computing system. Other methods for performing the electrical connection between the multi-core processor 200 and the computing system exist and could also be used, including, but not limited to, reflow of solder balls. The multi-core processor 200 in this embodiment is depicted as one piece of silicon that contains two separate cores 204 capable of performing parallel independent processor computing instructions. Another example, not depicted in the embodiment, includes two pieces of separate silicon enclosed on the same package with the purpose of creating a multi-core processor computing system. Another example, not depicted in the embodiment, includes one piece of silicon that contains four cores which is enclosed in a package. In each example, the individual cores making up the multi-core processor 200 are designed and manufactured with the ability to operate independent of the other cores when instructed and accessed by more than one user. The independent operation of each core within the multi-core processor is managed by the software and hardware of the computing system.

FIG. 3 is a depiction of the apparatus and method for remote computer access of a multi-core processor computer according to an embodiment. The computing system 300 is used as the central hub that is capable of interacting with at least one remote access site. The computing system 300 includes, but not limited to, a housing terminal 301, a multi-core processor 302, a wireless communicator 303, a monitor 304, and a keyboard 305. The remote access site 306 includes at least one display monitor 307 and may include interface devices such as keyboard and mouse 308. A wireless communicator 309 is connected to the remote access site 306 hardware. In this depiction, the wireless communicator 309 is housed within the monitor 307. The wireless communicator 309 enables the remote access site 306 to establish wireless contact 310 and both receive and transmit information and requests without the need for wires using, but not limited too, wireless fidelity standards. The remote access site 306 depicted in this example does not require a central processing unit processor.

FIG. 3 also depicts the interaction between the computing system 300 and the remote access site 306 according to the embodiment 310. The wireless communicator 303 of the computing system 300 and the wireless communicator 309 of the remote access site 306 can both simultaneously transmit and receive information and instructions from each site. For instance, a user at remote access site 306 could log on to the remote access site 306. The wireless communicator 309 at the remote access site 306 would then establish wireless contact 310 with computing system 300 via wireless protocols and exchange of information. Wireless connection 310 would continue until the user at remote access site 306 logs off the remote access site 306 or power is turned off.

FIG.4 is a depiction of the apparatus and method for remote computer access of a multi-core processor computer according to an embodiment. The computing system 400 is used as the central hub that is capable of interacting with at least one remote access site. The computing system 400 includes, but not limited to, a housing terminal 401, a multi-core processor 402, a wireless communicator 403, a monitor 404, and a keyboard 405. The remote access site 406 includes at least one display monitor 407 and may include interface devices such as keyboard and mouse 408. In this depiction, the wireless communicator 409 is housed within a separate hardware device 410. The hardware device 410 may also have expansion ports to permit additional remote access sites, not pictured in the depiction, to be added to utilize the wireless communicator 409 to communicate with the computing system 400. The wireless communicator 409 enables the remote access site 406 to establish wireless contact 411 and both receive and transmit information and requests without the need for wires using, but not limited too, wireless fidelity standards. The remote access site 406 depicted in this example does not require a central processing unit processor.

FIG. 5 is a process flow diagram according to an embodiment. The process flow 500 indicates the access process from the remote site to the computing system.

At 501, the process commences by turning on the power to the computing system enabling operation of the wireless communicator and other functions of the computing system. At 502, the software and hardware of the computing system begin to check if remote access is being requested by a remote access site.

At 503, a user powers on the remote access site and logs on to the system by requesting access to the computing system. At 504, the wireless communicator at the remote access site sends information to the computing system requesting access and waiting for response.

At 505, the computing system receives the request and approves request by remote access site. At 506, the computing system allocates a core within the multi-core processor to user of the remote access site. At 507, the computing system permits sharing of non-processor capabilities of the computing system to the user of the remote access site.

At 508, the remote access site user now has access to the computing capability of the computing system, including a core of the multi-core processor. At 509, wireless communication between the remote access site and the computing system continues for the duration of the user session.

At 510, the user at the remote access site logs off of the remote access site or powers off the remote access site. The wireless communicator sends request to the computing system to log off. At 511, the computing system receives request to log off or detects that the remote access site has powered off of the remote access site and grants request.

At 512, the computing system returns dedicated access to a core within the multi-core processor back to the computing system. Computing system now has access to the full processor capability of the multi-core processor.

The process flow returns to 502, whereby the computing system continues to detect if a request is being made by a remote access site to access the computing system.

It can now be appreciated that embodiments set forth in this disclosure can be applied to devices and apparatuses other than the traditional computer. For example, a computing system with the embodiment of the multi-core processor and the wireless communicator depicted in FIG. 1 could be placed in a home media entertainment center, such that, in this example, a computing system could utilize one of the cores of the multi-core processor to download a movie from the internet for display on a television for home media entertainment, while a remote user, at the same time, is accessing the computing capability of the multi-core processor from the remote station with the associated wireless communicator. Another example is a computing system being placed in a vehicle such as an automobile, a locomotive, a watercraft, an aircraft, or a spacecraft.

It is emphasized that the Abstract is provided to comply with regulations requiring an Abstract that will allow the reader to quickly ascertain the nature and gist of the technical disclosure. It is submitted with the understanding that it will not be used to interpret or limit the scope or meaning of the claims.

In the foregoing Description, various features are grouped together in a single embodiment for the purpose of streamlining the disclosure. This method of disclosure is not to be interpreted as reflecting an intention that the claimed embodiments of the invention require more features that are expressly recited in each claim. Rather, as the following claims reflect, inventive subject matter lies in less than all features of a single disclosed embodiment. Thus the following claims are hereby incorporated into the Description, with each claim standing on its own as a separate preferred embodiment.

It will be readily understood to those skilled in the art that various other changes in the details, material, and arrangements of the parts and method stages which have been described and illustrated in order to explain the nature of this subject matter may be made without departing from the principles and scope of the subject matter as expressed in the subjoined claims.

What is claimed is:

1. A computing system comprising: A computer equipped with at least one multi-core processor as the central processing unit and a wireless communicator that permits access to the computing system from at least one remote access site consisting of a monitor, keyboard, and pointer device. This remote access site would also be equipped with a wireless communicator that can establish contact with the central computer equipped with at least one multi-core processor. Those skilled in the art can recognize various configurations in the integration of the wireless communicator at the remote access site to seamlessly connect the peripheral hardware.

2. The computing system according to claim 1, wherein a user can access the computing capability of the multi-core processor without a host or server computer from a remote access site using the wireless communicator(s) equipped at a remote access site in the hardware consisting of, but not limited to a monitor, keyboard, and mouse.

3. The computing system according to claim 1, wherein a user can access the computing capability of the multi-core processor with a host or server computer equipped with a processor from the remote access site using the wireless communicator(s) equipped at the remote access site in the hardware consisting of, but not limited to a monitor, keyboard, and mouse.

4. The computing system according to claim 1, wherein a remote user can access the computing capability in parallel with a direct user of the multi-core processor computer system, thereby permitting multiple users independent capability to access and use the capabilities of the multi-core processor computer system. The number of independent users will be in correlation to the number of cores in the multi-core processor computer system comprised of at least one multi-core processor.

5. A process comprising: of wireless access to the computing system without the need for a network computer or host terminal by using remote hardware, including, but not limited to, a monitor, keyboard, and a mouse equipped with a wireless communicator(s) that communicates with the computing system as outlined in claim 1.

6. A process comprising of the computing system in claim 1, that can detect requested access from the remote access site as described in claim 2, and permit access to the computing capability on the computing system by allocating processor and computing capability on the computer system with the multi-core. In effect, allowing a user at a remote access site dedicated access to a particular core within the multi-core processor for dedicated independent processing capability in parallel with other users, both users from remote access sites and a direct user of the multi-core processor computing system.

7. A process comprising of the computing system in claim 1, that can detect requested access from the remote access site as described in claim 2, and permit access to the computing capability on the computing system by sharing non-processor computing capabilities on the computer system including, but not limited too, memory functions, chipset functions, internet access, and input/output devices such as a printer and a modem. In effect, allowing a user from a remote access site to share the non-processor capabilities of the computing system.

8. A process comprising of computing system in claim 1 that can self-optimize the allocation of the multi-core processor. This optimization by the computing system software and hardware would allocate processing capability of the multi-core processor cores based on the number of remote site users detected accessing the computer system in claim 1 relative to the number of cores in the multi-core processor.

9. A process comprising of computing system in claim 1 that permits the user of the computing system to set the allocation procedures of the multi-core processor using software incorporated into the computing system. These allocation procedures set by the user of the computing system would dictate the protocol and privileges granted to users of remote access sites requesting permission to access the computing system. The allocation procedures established by the user of the computing system would include determining the priority of requests from multiple users at remote access sites for accessing allocation of the multi-core processor in the computing system.

10. A hardware device equipped with a wireless communicator that can permit remote site access to a computing system. This hardware device can permit multiple remote site hardware and peripherals to be connected at one site and permit independent access to the computing system via the equipped wireless communicator. The hardware device manages multiple remote site access while maintaining communication with the central computing system via wireless communicators.
